(19) United States
(12) Patent Application Publication
(10) Pub. No.: US 2019/0305663 A1
(43) Pub. Date: Oct. 3, 2019

(54) CLEAN ENERGY GENERATING DEVICE

(71) Applicant: Chun-Yung LIN, Taichung City (TW)

(72) Inventor: Chun-Yung LIN, Taichung City (TW)

(21) Appl. No.: 15/942,611

(22) Filed: Apr. 2, 2018

(51) Int. Cl. H02K 53/00; H02K 1/12; H02K 7/02; H02K 49/10

(52) U.S. Cl. CPC H02K 53/00; H02K 49/10; H02K 7/02; H02K 1/12

(57) ABSTRACT

A clean energy generating device has a frame, a transmitting module, a driving motor, and an accelerator. The transmitting module, the driving motor and the accelerator are respectively mounted to the frame. The transmitting module has a driving wheel, a driven wheel, and a transmitter. The driving wheel and the driven wheel are rotatably mounted to the frame, respectively, and are both engaged by the transmitter. Furthermore, the driven wheel has a magnetizable ring, which axially protrudes from one side of the driven wheel and forms a surrounded space. The accelerator has a motor and a magnet. The magnet is mounted to an axle of the motor, and extends to the surrounded space of the magnetizable ring. By rotating the magnet, magnetic attraction drives and accelerates the driven wheel.

### BACKGROUND OF THE INVENTION

### 1. Field of the Invention

The present invention relates to an energy generating device, and more particularly to a clean energy generating device that is accelerated by magnetic force, and therefore improves the efficiency in generating clean energy.

### 2. Description of Related Art

Global warming causes climate changes all over the world, which has become a major issue in recent years. As a result, pollutants that lead to global warming have caught public attention. For instance, coal-fired power station not only emits a large amount of waste heat and greenhouse gases, but also increases the particulate matters such as PM 2.5 (Particulate Matter), which is notorious for causing respiratory diseases.

As a result, people looking forward to resolving the environmental problems turn to green and low-polluting energy, which can replace the energy outputted from coal-fired power station. Conventional clean energy generating devices use techniques of two major sources: wind power and solar power. However, due to demand for large lands and stable weather, both of the sources are unable to be installed in factories or commercial facilities.

In addition, for factories and commercial facilities, a conventional technique motivates a flywheel to rotate by a power source. The flywheel has an axle which is connected with an electric generator to generate a rotational energy, and the electric generator turns the rotational energy of the flywheel to electric energy. In this way, energy generating efficiency cannot be raised under the same power source, since the energy output completely relies on the power source. Therefore, the conventional technique has a shortcoming of low generating efficiency, which further leads to use difficulties.

### SUMMARY OF THE INVENTION

The main objective of the present invention is to provide a clean energy generating device that may improve the efficiency in generating electricity, and take advantage of power waste from factories and commercial facilities.

The clean energy generating device comprises a frame, a transmitting module, a driving motor, and an accelerator. The frame is mounted upright on the ground. The transmitting module is connected to the frame and comprises a driving wheel, a driven wheel, and a transmitter. The driving wheel and the driven wheel are rotatably mounted to the frame, respectively, and are spaced from each other at an interval. The transmitter connects the driving wheel and the driven wheel. Furthermore, the driven wheel has a rotating axle and a magnetizable ring, wherein the magnetizable ring axially protrudes from one of two sides of the driven wheel and forms a surrounded space. The driving motor is mounted to the frame and has a driving axle, wherein the driving axle is connected to the driving wheel and enables the driving wheel to rotate. The accelerator comprises a motor and a magnet. The motor has an axle, and is mounted to the frame at a position near the magnetizable ring. The magnet is mounted to the axle of the motor, and extends to the surrounded space of the magnetizable ring.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a clean energy generating device in accordance with the present invention;

FIG. 1A is a partially enlarged perspective view of the clean energy generating device in FIG. 1;

FIG. 2 is a front side view of the clean energy generating device in FIG. 1;

FIG. 3 is a partially enlarged top side view of the clean energy generating device in FIG. 1; and

FIG. 4 is an operational front side view of the clean energy generating device in FIG. 1.

### DETAILED DESCRIPTION OF THE PREFERRED EMBODIMENT

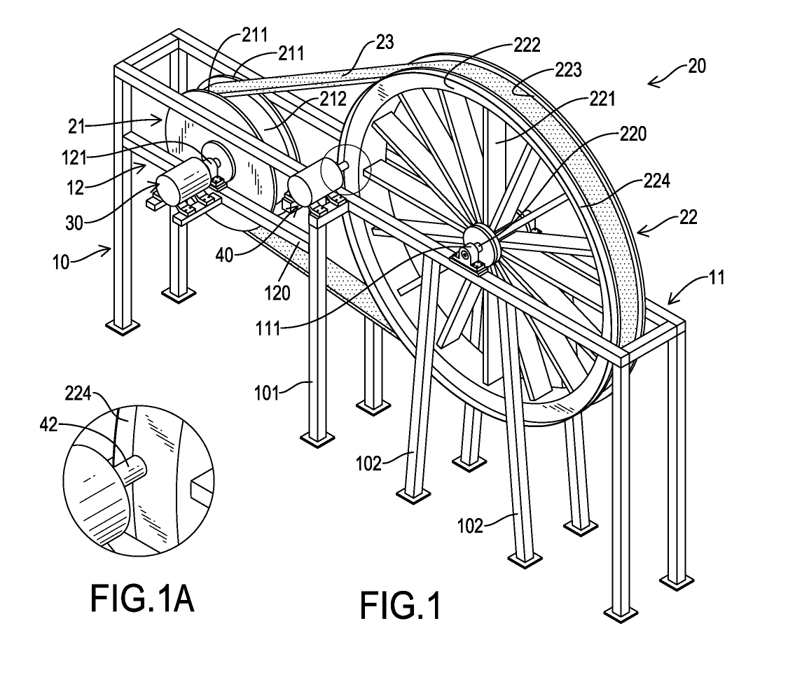

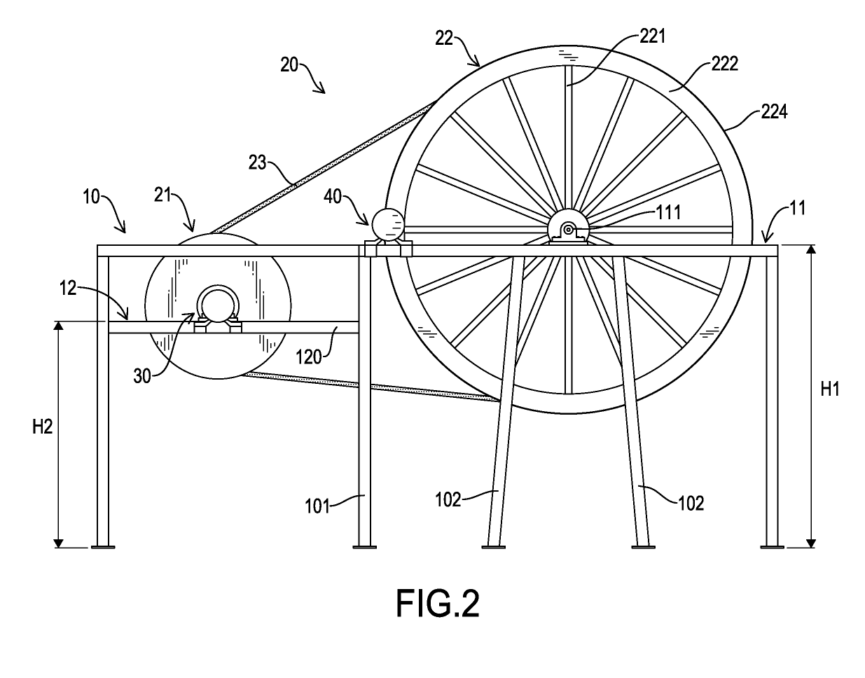

With reference to FIGS. 1, 1A, and 2, a clean energy generating device in accordance with the present invention comprises a frame 10, a transmitting module 20, a driving motor 30, and an accelerator 40.

The frame 10 has a first rack 11 and a second rack 12. The first rack 11 is a horizontal rectangular frame composed of multiple H-beams. The first rack 11 has two long sides and two first bearings 111. The two first bearings 111 are respectively located on the two long sides of the first rack 11, and the two first bearings 111 are aligned with each other.

Furthermore, the first rack 11 is formed by multiple studs 101 and multiple braces 102 connected to each other. The multiple studs 101 are vertically mounted on the ground. Top ends of the studs 101 are connected to the first rack 11, and thus the first rack 11 is at a first height H1. In the present embodiment, there are four braces 102. Each one of the braces 102 is connected to the first rack 11, with one end mounted to a position beside one of the two first bearings 111. That is, each one of the first bearings 111 has a respective brace mounted near each one of the two sides of the corresponding first bearing 111. In addition, each one of the braces 102 extends away from one of the first bearings 111, and is further inclined and stuck to the ground. Each one of the studs 101 and the braces 102 is an H-beam.

The second rack 12 is parallel to the first rack 11 and located below a portion of the first rack 11, wherein the portion is away from the two first bearings 111. The second rack 12 comprises two arms 120, where each one of the two arms 120 is an H-beam. The two arms 120 are respectively mounted to four of the studs 101, and the two arms 120 are located below the two long sides of the first rack 11, respectively. As a result, the second rack 12 is at a second height H2, and the second height H2 is lower than the first height H1 of the first rack 11. Moreover, each one of the two arms 120 has a second bearing 121. The two second bearings 121 are aligned with each other.

The transmitting module 20 is mounted to the frame 10. The transmitting module 20 comprises a driving wheel 21, a driven wheel 22, and a transmitter 23. The driving wheel 21 is connected to the second rack 12. The driving wheel 21 has an axle rotatably mounted to the two second bearings 121 of the second rack 12, so the driving wheel 21 can rotate between the two arms 120 of the second rack 12. The driving wheel 21 further has an outer diameter, two circumferences 211 and a groove 212. The two circumferences 211 are radially protruded from two sides of the driving wheel 21, respectively. The groove 212 is formed between the two circumferences 211, and surrounds the driving wheel 21.

The driven wheel 22 is rotatably mounted to the first rack 11, and is spaced from the driving wheel 21 at an interval. The driven wheel 22 has an outer diameter larger than the outer diameter of the driving wheel 21. Furthermore, the driven wheel 22 has a rotating axle 220, multiple spokes 221, a rim 222, a recess 223, and a magnetizable ring 224.

The rotating axle 220 is rotatably mounted to the two first bearings 111, and the rotating axle 220 further axially extends so as to connect to an electric generator. The multiple spokes 221 radially extend from the rotating axle 220. The rim 222 is connected with the multiple spokes 221. Two sides of the rim 222 radially protrude as two protrusions, and the recess 223 is formed between the two protrusions. The magnetizable ring 224 axially protrudes from one of the two sides of the rim 222, and a surrounded space is formed inside the magnetizable ring 224. Moreover, in the present embodiment, the magnetizable ring 224 is a steel ring.

The transmitter 23 is a belt engaged in the groove 212 and the recess 223, so as to connect the driving wheel 21 and the driven wheel 22. As a result, the driven wheel 22 rotates via transmission of the transmitter 23, as the driving wheel 21 rotates.

The driving motor 30 is mounted to the frame 10 and connected to one of the two arms 120. The driving motor 30 has a driving axle connected to the axle of the driving wheel 21. Therefore, when the driving motor 30 is operating, the driving wheel 21 can rotate relative to the two racks 11, 12.

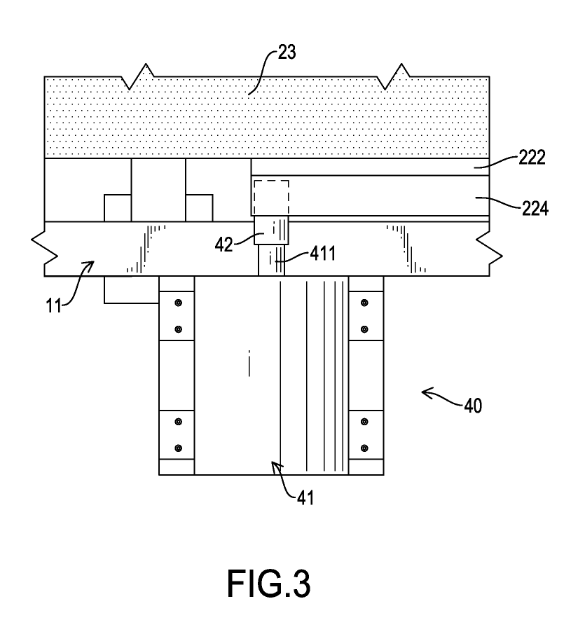

With reference to FIGS. 1 to 3, the accelerator 40 is mounted to the frame 10 near the magnetizable ring 224 of the driven wheel 22. The accelerator 40 comprises a motor 41 and a magnet 42. The motor 41 is connected to the first rack 11, and has an axle extending toward the driven wheel 22. The magnet 42 is engaged with the axle of the motor 411, and rotatably extends to the surrounded space formed by the magnetizable ring 224. Rotation of the magnet 42 leads to variations in the magnetic field. Thus, the magnetizable ring 224 relatively rotates due to induction of the magnet 42, and further accelerates the rotation of the driven wheel 22.

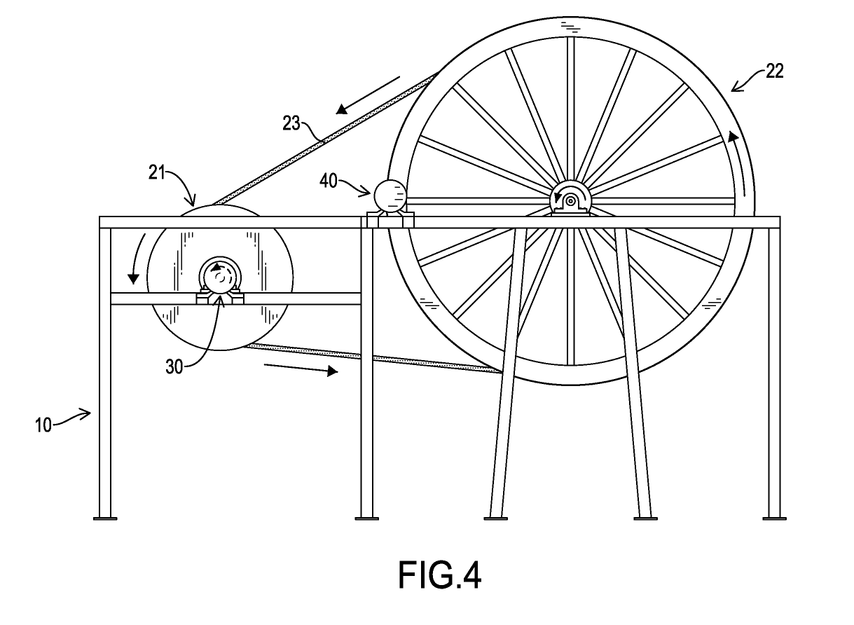

With reference to FIG. 4, the driving motor 30 may be connected to an outer power source, in order to work and further to drive the driving wheel 21. As shown in FIG. 4, the driving wheel is rotated along a counterclockwise direction, so the transmitter 23 that is connected to the driving wheel 21 and the driven wheel 22 can make the driven wheel 22 rotate as well. The electric generator is therefore able to output electricity because the driving torque comes from the rotating axle 220 of the driven wheel 22. Furthermore, the motor 41 of the accelerator 40 is connected to an input source, where the input source can be electric power waste emitted from factories or commercial facilities. So the motor 41 supported by the power waste can make the magnet 42 rotate together, and further attract the magnetizable ring 224 to accelerate the rotation of the driven wheel 22. As a result, the efficiency in generating electricity rises. That is to say, the present invention takes advantage of the power waste to promote the working efficiency of the electric generator.

In the present embodiment, the driving wheel 21 has a diameter of one meter, the driven wheel 22 has a diameter of 10 meters, and the driven wheel 22 weighs 50 tons. The axle of the driving wheel 21 is at a lower position than the axle of the driven wheel 22 as the second height H2 is smaller than the first height H1. So when the transmitting module 20 is under operation, with reference to FIG. 4, the upper portion of the transmitter 23, which pulls the driven wheel 22 toward the driving wheel 21, has a larger inclined angle. The larger inclined angle enables the transmitter 23 to exert downward pressure on the driven wheel 22, and further improves the effect of transmission between the two wheels 21, 22. In addition, the four braces 102 provide the driven wheel 22 with a firm support.

With the aforementioned technical characteristics, the clean energy generating device has the following advantages.

1. The present invention uses neither coal-fired technology nor green energy susceptible to weather changes such as wind power, solar power, or hydraulic power, and the present invention also works with low noise. So it is suitable to be installed in factories or commercial facilities.

2. The accelerator 40 takes advantage of power waste from the buildings, and can successfully gain more energy output under the same input source, in comparison with the prior art.

Even though numerous characteristics and advantages of the present utility model have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A clean energy generating device comprising:
a frame mounted uprightly on the ground;
a transmitting module mounted to the frame and comprising
a driving wheel rotatably mounted to the frame;
a driven wheel rotatably mounted to the frame, spaced from the driving wheel at an interval, and having
a rotating axle; and
a magnetizable ring axially protruding from one of two sides of the driven wheel and forming a surrounded space; and
a transmitter connected to the driving wheel and the driven wheel;
a driving motor mounted to the frame and having a driving axle, wherein the driving axle is connected to the driving wheel and drives the driving wheel to rotate; and
an accelerator mounted to the frame and comprising
a motor mounted to the frame at a position near the magnetizable ring and having an axle; and
a magnet mounted to the axle of the motor, and extending to the surrounded space of the magnetizable ring.

2. The clean energy generating device as claimed in claim 1, wherein the frame comprises
a first rack mounted to the driven wheel; and
a second rack being at a lower position than the first rack and mounted to the driving wheel.

3. The clean energy generating device as claimed in claim 1, wherein the transmitter is a belt wrapped on the driving wheel and the driven wheel.

4. The clean energy generating device as claimed in claim 2, wherein the transmitter is a belt wrapped on the driving wheel and the driven wheel.

5. The clean energy generating device as claimed in claim 3, wherein the driving wheel comprises
two circumferences radially protruded from two sides of the driving wheel, respectively; and
a groove formed between the two circumferences and surrounding the driving wheel.

6. The clean energy generating device as claimed in claim 4, wherein the driving wheel comprises
two circumferences radially protruded from two sides of the driving wheel, respectively; and
a groove formed between the two circumferences and surrounding the driving wheel.

7. The clean energy generating device as claimed in claim 3, wherein the driving wheel further has an outer diameter, and the driven wheel further has
an outer diameter larger than the outer diameter of the driving wheel;
multiple spokes radially extending from the rotating axle;
a rim connected with the multiple spokes, wherein two sides of the rim radially protrude as two protrusions; and
a recess formed between the two protrusions, and the transmitter engaged in the recess.

8. The clean energy generating device as claimed in claim 4, wherein the driving wheel further has an outer diameter, and the driven wheel further has
an outer diameter larger than the outer diameter of the driving wheel;
multiple spokes radially extending from the rotating axle;
a rim connected with the multiple spokes, wherein two sides of the rim radially protrude as two protrusions; and
a recess formed between the two protrusions, and the transmitter engaged in the recess.

9. The clean energy generating device as claimed in claim 5, wherein the driving wheel further has an outer diameter, and the driven wheel further has
an outer diameter larger than the outer diameter of the driving wheel;
multiple spokes radially extending from the rotating axle;
a rim connected with the multiple spokes, wherein two sides of the rim radially protrude as two protrusions; and
a recess formed between the two protrusions, and the transmitter engaged in the recess.

10. The clean energy generating device as claimed in claim 6, wherein the driving wheel further has an outer diameter, and the driven wheel further has
an outer diameter larger than the outer diameter of the driving wheel;
multiple spokes radially extending from the rotating axle;
a rim connected with the multiple spokes, wherein two sides of the rim radially protrude as two protrusions; and
a recess formed between the two protrusions, and the transmitter to be engaged in the recess.

11. The clean energy generating device as claimed in claim 9, wherein the frame further has four braces, and each one of the four braces is connected to the first rack, with one end of the brace mounted to a position beside one side of the rotating axle, and another end of the brace inclined and stuck to the ground.

12. The clean energy generating device as claimed in claim 10, wherein the frame further has four braces, and each one of the four braces is connected to the first rack, with one end of the brace mounted to a position beside one side of the rotating axle, and another end of the brace inclined and stuck to the ground.
